(19) United States
(12) Patent Application Publication
(10) Pub. No.: US 2018/0365197 A1
(43) Pub. Date: Dec. 20, 2018

(54) AUTOMATIC UPLOAD AND INSTANT PREVIEW GENERATION OF LOCALLY UNSUPPORTED FILES

(71) Applicant: MICROSOFT TECHNOLOGY LICENSING, LLC, Redmond, WA (US)

(72) Inventors: Jose Emmanuel MIRANDA-STEINER, Seattle, WA (US); John D. RODRIGUES, Woodinville, WA (US); Steven J. BAILEY, Bellevue, WA (US)

(73) Assignee: MICROSOFT TECHNOLOGY LICENSING, LLC, Redmond, WA (US)

(21) Appl. No.: 15/624,719

(22) Filed: Jun. 16, 2017

(51) Int. Cl. G06F 17/21; H04L 29/08; G06F 17/30; G06Q 30/02

(52) U.S. Cl. CPC G06F 17/212; H04L 67/1097; H04L 67/42; G06Q 30/0207; G06F 17/30106

(57) ABSTRACT

Technologies are provided for an instant preview of a locally unsupported file. A client application such as a file synchronization application may detect an intent to preview a locally stored file. Upon detection and determination that there is no local preview support is available, the client application may send the file to a cloud based service such as a cloud storage service. The cloud based service may search to determine if a cloud based previewer associated with the file is registered with the service. If no such previewer is found, the service may seek one from an external resource. Upon finding a previewer associated with the file, the cloud based service may generate a preview for the file and transmit to the client application to be rendered. The cloud based service may remove the cloud copy of the file upon completion in some examples.

### BACKGROUND

Information exchange has changed processes associated with work and personal environments. Automation and improvements in processes have expanded the scope of capabilities offered for personal and business data consumption. With the development of faster and smaller electronics, execution of mass processes at cloud systems have become feasible. Indeed, applications provided by data centers, data warehouses, and data workstations have become common features in modern personal and work environments. Cloud based storage service(s) provide hosting, management, and/or other file service(s) that encompass a multitude of file types for which a client application may lack support.

Increasingly, cloud based resources are utilized for variety of services that include hosting and/or management services, among others that facilitate hosting, processing, classification, and/or management, among other operations associated with assets such as files. However, there are currently substantial gaps in dynamically providing content preview support in client application(s). Personnel resources are unnecessarily consumed for managing and creating support for a multitude of file types that are hosted by cloud based services. Lack of relevant preview solutions to dynamically render content of locally stored file(s) causes poor management of personnel resources and time when attempting to preview locally stored file(s).

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to an instant preview of an unsupported file. A cloud based service may receive a locally stored file from a client application upon detection of user interest on the file by the client application and confirmation that there is no local preview support for the file. The service may determine a previewer for the file among previewers registered with the service or from an external resource if there is no applicable previewer registered with the service. The service may generate a preview of the file using the determined previewer and transmit the preview to the client application. Subsequently, the service may remove the cloud copy of the file. The preview may be a rich instant preview with particular levels of functionality such as editing functionality.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of providing an instant preview of a locally unsupported file, according to embodiments;

FIG. 2 is a display diagram illustrating example components and actions in a first phase of providing an instant preview of a locally unsupported file, according to embodiments;

FIG. 3 is a display diagram illustrating example components and actions in a second phase of providing an instant preview of a locally unsupported file, according to embodiments;

FIG. 4 is a display diagram illustrating example components and actions in a third phase of providing an instant preview of a locally unsupported file, according to embodiments;

FIG. 5 is a display diagram illustrating an example of a scheme to provide an instant preview of a locally unsupported file, according to embodiments;

FIG. 6 is a simplified networked environment, where a system according to embodiments may be implemented;

FIG. 7 is a block diagram of an example computing device, which may be used to provide an instant preview of a locally unsupported file, according to embodiments; and

FIG. 8 is a logic flow diagram illustrating a process for providing an instant preview of a locally unsupported file, according to embodiments.

### DETAILED DESCRIPTION

As briefly described above, a file management and/or synchronization application may provide an instant preview of a locally unsupported file. In an example scenario, a client application such as a file synchronization application may detect an intent to preview a locally stored file. Upon detection, the client application may determine if there is a local previewer available for the file. If no local preview support is available, the client application may send the file to a cloud based service such as a cloud storage service. The cloud based service may search to determine if a cloud based previewer associated with the file is registered with the service. If no such previewer is found, the service may seek one from an external resource. Upon finding a previewer associated with the file, the cloud based service may generate a preview for the file and transmit to the client application to be rendered. The cloud based service may remove the cloud copy of the file upon completion in some examples. In other examples, the cloud based service may offer a user an incentive to subscribe to the service and keep the cloud copy of the file as part of the subscription.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing an instant preview of a locally unsupported file. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

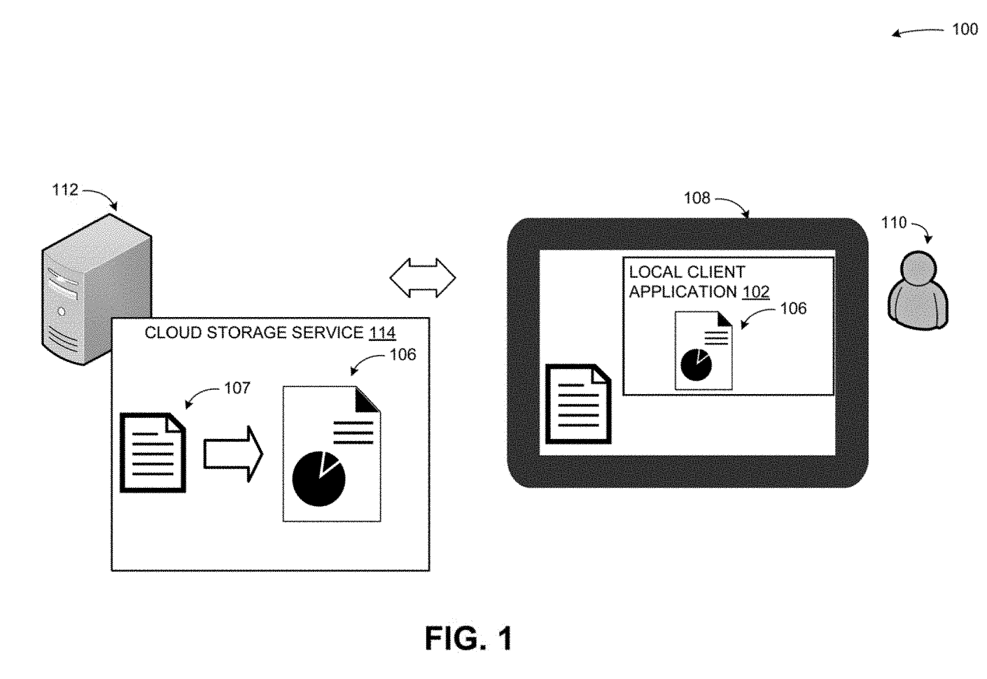

FIG. 1 is a conceptual diagram illustrating examples of providing an instant preview of a locally unsupported file, according to embodiments.

In a diagram 100, a computing device 108 may execute (or provide) a local client application 102, which may in some examples be file management application or a synchronization application. The local client application 102 may also be another type such as a client application of a collaboration service, a productivity service, and so on. The computing device 108 may include a desktop device and/or a mobile device application(s) such as the local client application 102. The computing device 108 may interact with a server 112 that executes a cloud storage service 114. A service (such as the cloud storage service 114) may include an application performing operations in relation to a client application and/or a subscriber, among others. The server 112 may include and/or is part of a workstation, a data warehouse, a data center, and/or a cloud based distributed computing source, among others.

The computing device 108 may execute the local client application 102. The local client application 102 may detect an intent to preview a locally stored file 107 and send a copy of the locally stored file 107 to the cloud storage service 114, which as described above, may search and determine a previewer associated with a type of the locally stored file 107, generate a preview 106 for the locally stored file 107, and send back to the local client application 102 to be rendered.

The local client application 102 may be a client application of the cloud storage service 114 or may be associated with another service. The local client application may allow users to interact with and access services provided by the cloud storage service 114 or another service. For example, the local client service 102 may be associated with a productivity service, a collaboration service, a communication service, and similar ones.

Upon confirming a lack of a local previewer associated with the locally stored file 107, the local client application 102 may request the preview 106 from the cloud storage service 114 provided by the server 112 by sending a copy of the locally stored file 107 to the server. The cloud storage service 114 may host the locally stored file 107 temporarily until the preview 106 of the file is generated. The preview 106 may include a presentation of the locally stored file 107. The presentation may include image(s) of a content of the locally stored file 107. In another example scenario, the preview 106 may also have interactive element(s) that may be located in the locally stored file 107 (such as a fillable form). Upon receiving the preview 106 associated with the locally stored file 107 from the cloud storage service 114 provided by the server 112, the local client application 102 may render the preview 106. Alternatively, the local client application 102 may instruct the operating system (executed by the computing device 108) to have the preview 106 rendered by other application and/or module capable of rendering the preview 106.

The computing device 108 may communicate with the server 112, and/or other cloud based storage provider, through a network. The network may provide wired or wireless communications between network nodes such as the computing device 108, the server 112, and/or the cloud based storage provider, among others. Previous example(s) to provide an instant preview of the locally stored file 107 are not provided in a limiting sense. Alternatively, the file management application 102 may render the preview 106 as a desktop application, a workstation application, and/or a server application, among others.

A user 110 may interact with the local client application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 108, the local client application 102, embodiments are not limited to these components or system configurations and can be implemented with other system configuration employing fewer or additional components.

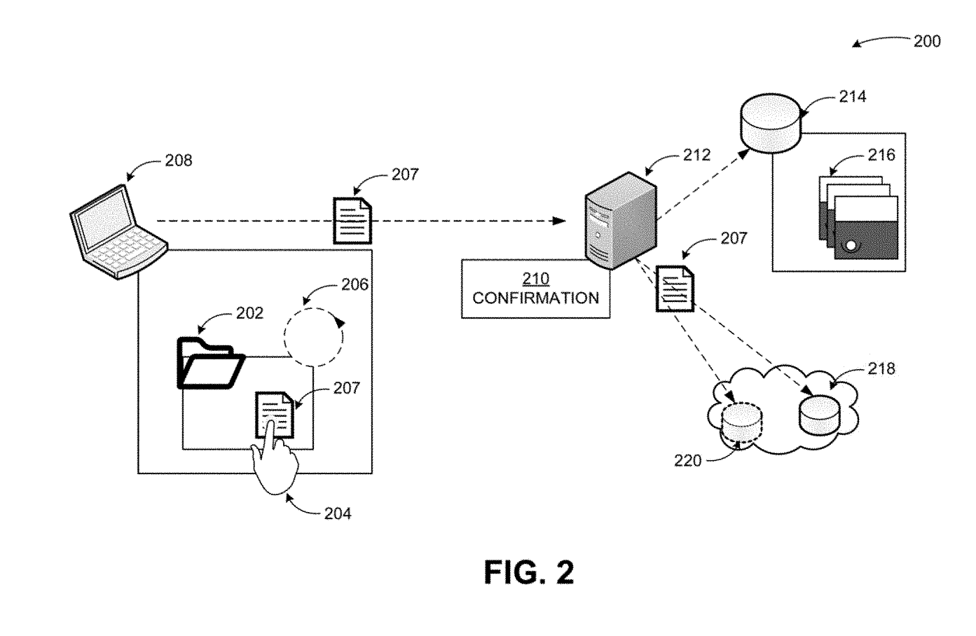

FIG. 2 is a display diagram illustrating example components and actions in a first phase of providing an instant preview of a locally unsupported file, according to embodiments.

As illustrated in diagram 200, a file 207 may be stored locally at a computing device 208, for example in folder 202 of a hard drive of the computing device. A client application may provide services associated with the file 207 such as executing the file, processing the file, sharing the file, etc. A user interface of the client application may present a representation of the file 207 such as an icon or comparable image/graphic. A user interest in file 207 may be detected by a hovering action or clicking or tapping on the representation of the file 207. Upon detecting the interest, the client application may first perform a check 206 to determine if a local previewer is available for the file 207, for example, by querying the operating system. If no previewer is available locally, the client application may send a copy of the file 207 to a cloud service executed on a server 212, for example. The cloud service (e.g., a cloud storage service) may first determine if the user is a subscriber, that is, if the user has an account with the cloud service. If the user is a subscriber, the copy of the file 207 may be stored at a cloud storage 218 and subsequently synchronized with the local version. If the user is not a subscriber, the copy of the file 207 may be stored at a temporary cloud storage 220.

The cloud service may then confirm (210) that there is a previewer available for the file 207 among its registered previewers 216 at an associated store 214. As discussed above, the cloud service may include a cloud storage service, a productivity service, a collaboration service, a communication service, and any comparable cloud service. The client application may be an independent locally installed application, a client application directly connected to the cloud service, or a module within an operating system of the computing device 208.

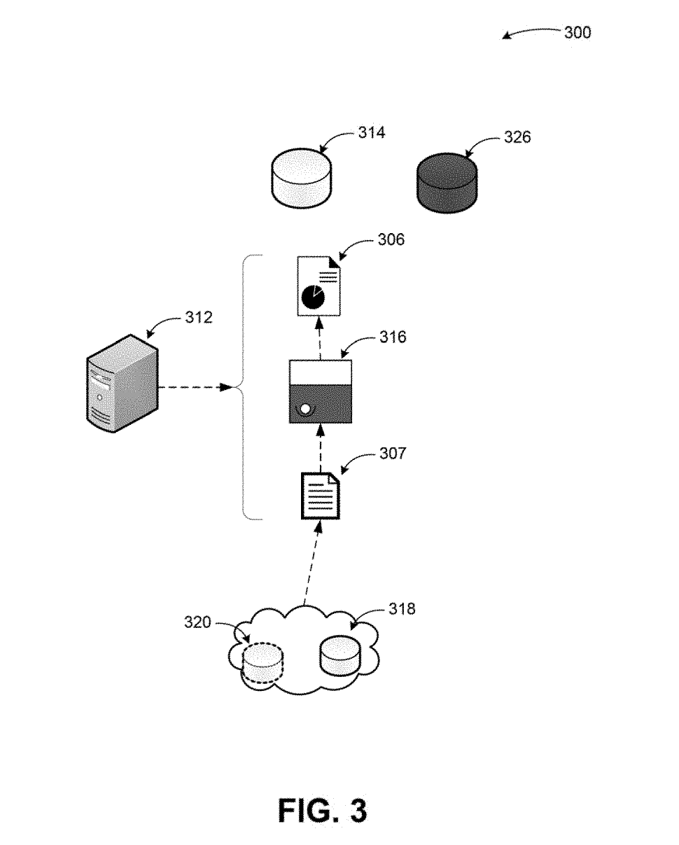

FIG. 3 is a display diagram illustrating example components and actions in a second phase of providing an instant preview of a locally unsupported file, according to embodiments.

As shown in a diagram 300, the cloud service executed on server 312 may not always have a registered previewer available for a type of the file 307 in its store 314. In such a scenario, the cloud service may query an external source 326 such as an application store, a database of a preview provider, etc. and receive an applicable previewer from the external source 326. Upon determining/obtaining the previewer 316 through one of the above-described approaches, the cloud service may retrieve the file 307 from one of the data stores 318 or 320 (permanent or temporary) and generate a preview 306 using the previewer 316. The preview 306 may range from one or more images reflecting a content of the file 307 to a more complex version with interactive and/or editable elements. Thus, the preview 306 may allow a user to simply view the content or interact with the content and edit the content of the file 307 at varying levels.

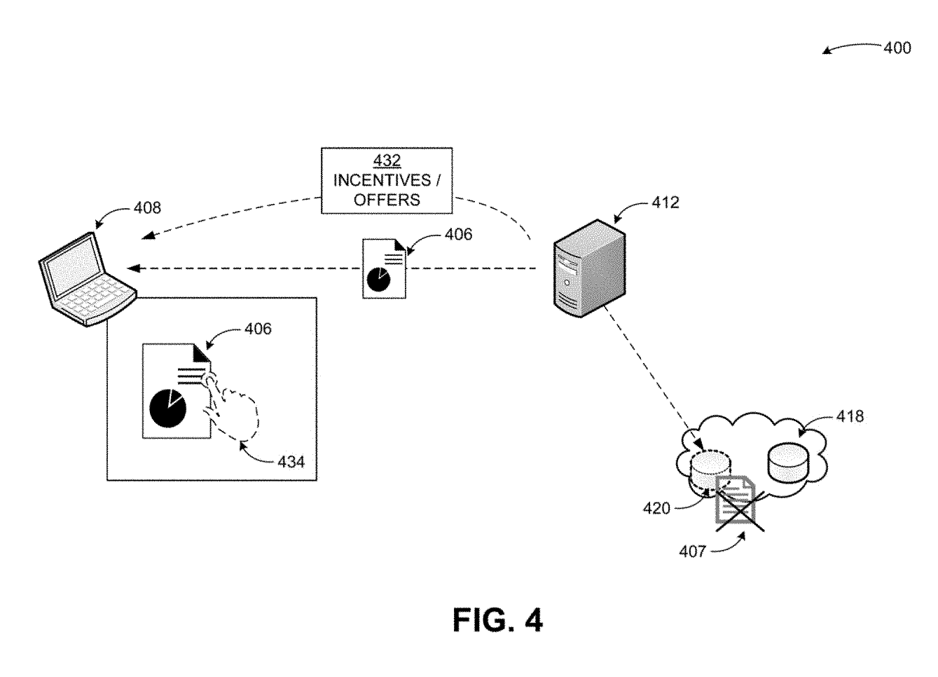

FIG. 4 is a display diagram illustrating example components and actions in a third phase of providing an instant preview of a locally unsupported file, according to embodiments.

As shown in diagram 400, the cloud service executed at server 412 may send the preview 406 to the computing device 408 to be rendered by the client application to the user. In the example scenario, where the user is not a subscriber, the cloud stored copy of the file 407 may be removed from the temporary storage 420. If the user is a subscriber, the cloud stored copy of the file 407 may be left at cloud storage 418 for future use by the user. As discussed above, the preview 406 may allow a user to simply view the content or interact with the content and edit the content of the file 407 at varying levels.

In some examples, the cloud service may provide incentives or offers 432 to the user to encourage the user to subscribe to the cloud service. The preview 406 may be utilized for that purpose. For example, a non-subscriber user may be provided simple version of the preview (e.g., read only) along with an option to receive higher functionality version(s) that allow editability or other interactivity with the file content if the user subscribes. In another example, the initial preview or a number of previews may be provided with higher functionality followed by a simpler version unless the user subscribes after a predetermined number of previews (for the same file or different files).

In further examples, users with different subscription levels may be provided different levels of interactivity or editability function by the preview. In yet other examples, a preview provider may allow higher functionality and include advertisements or other marketing material in the preview. Thus, the cloud service may act as an intermediary between users and preview providers. In such a role, the cloud service may collect statistical information such as file types for which previews are being sought for, number of attempts for previews, user types, and similar information. The information may be anonymized for protection of privacy and provided to preview providers to adjust their marketing strategies.

In some examples, the cloud service may implement security and privacy protection mechanisms such as removing file metadata before providing it to the preview generator, anonymizing user information, and confirming real user requests (as opposed to bot requests). In yet other examples, users may be allowed share the locally stored file with a preview. For example, a link may be sent to a recipient (e.g., a collaborator) to view the preview of the locally stored file for a limited number of times or for a limited time if the sender is not a subscriber. This functionality may further incentivize users to subscribe.

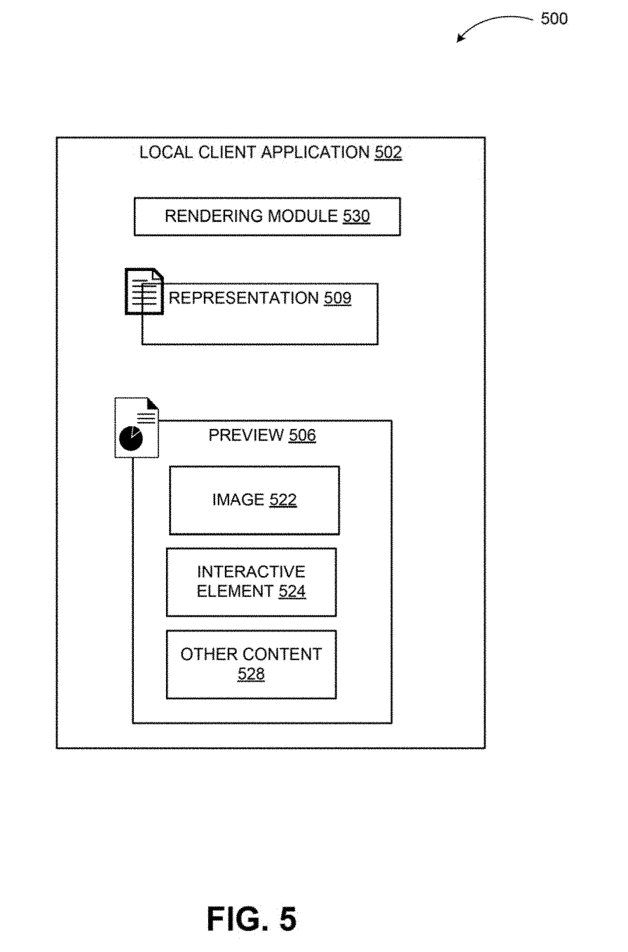

FIG. 5 is a display diagram illustrating an example of a scheme to provide an instant preview of a locally unsupported file, according to embodiments.

As shown in a diagram 500, a local client application 502 may include a rendering module 530 for rendering content of files and representations of files, such as representation 509, which may be a an icon, an image, or similar graphic. Upon receiving a preview 506 of a file, the rendering module 530 may also present the preview to a user. The preview 506, depending on its complexity, may include an image 522 (e.g., read only option), an interactive element 524 (e.g., forms or other elements), and other content 528 (e.g., editable text or graphics).

If the locally stored file is supported by a previewer available at the local environment (operating system of the computing device, for example), the rendering module 530 may generate the preview locally using the previewer and render the preview. If there is no local previewer available, the rendering module 530 or another component of the local client application 502 may provide a copy of the file to a cloud service, which may generate the preview through a previewer registered with the cloud service or obtained from an external source and send to the local client application 502.

Embodiments, as described herein, address a need that arises from a lack of efficiency to provide an instant preview of a locally stored file. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Providing an instant preview of a locally stored file may be implemented in configurations employing fewer or additional components in applications and user interfaces. Furthermore, the example schema and components shown in FIG. 1 through 5 and their subcomponents may be implemented in a similar manner with other values using the principles described herein.

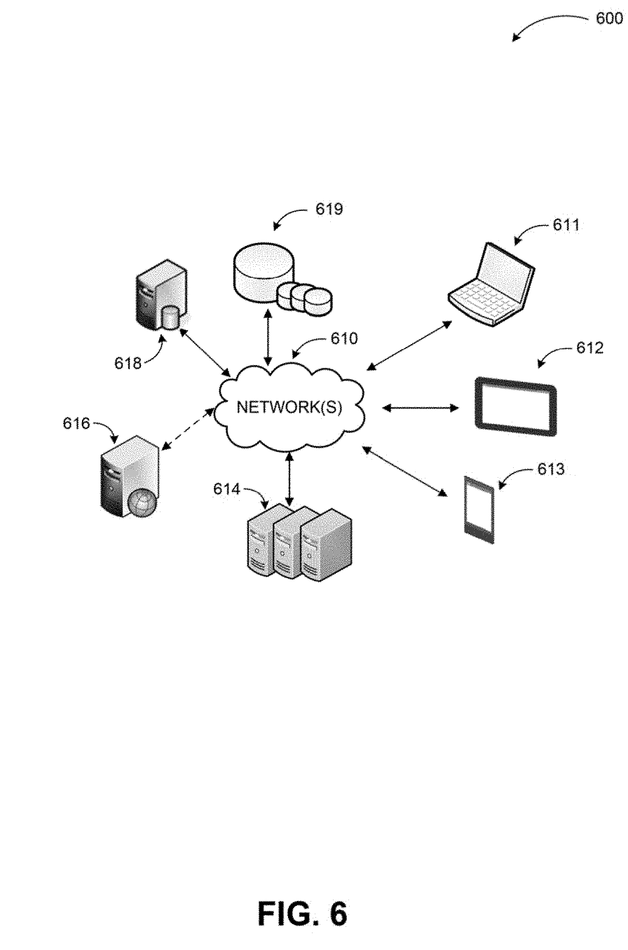

FIG. 6 is an example networked environment, where embodiments may be implemented. A local client application such as a file management and/or synchronization application may work with a cloud storage service configured to provide an instant preview of a locally stored file via software executed over one or more servers 614. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. A cloud based service executed on servers 614 or individual server 616 may receive a locally stored file from a client application upon detection of user interest on the file by the client application and confirmation that there is no local preview support for the file. The service may determine a previewer for the file among previewers registered with the service or from an external resource if there is no applicable previewer registered with the service. The service may generate a preview of the file using the determined previewer and transmit the preview to the client application. Subsequently, the service may remove the cloud copy of the file. The preview may be a rich instant preview with particular levels of functionality such as editing functionality. Data associated with the previews and previewers may be stored in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to provide an instant preview of a locally stored file. Furthermore, the networked environments discussed in FIG. 6 are for illustration purposes only. Embodiments are not limited to the example applications, modules, or processes.

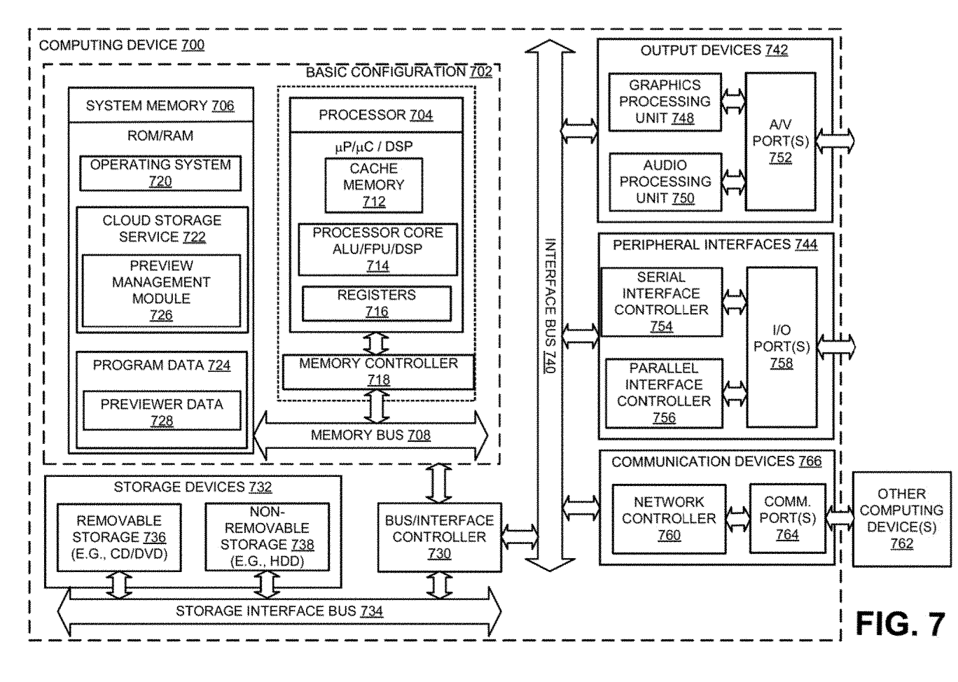

FIG. 7 is a block diagram of an example computing device, which may be used to provide an instant preview of a locally unsupported file, according to embodiments.

For example, computing device 700 may be used as a server, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), a graphics processing unit (GPU), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a cloud storage service 722, and a program data 724. The cloud storage service 722 may include components such as a preview management module 726. The preview management module 726 may execute the processes associated with providing instant previews for locally stored files such as receiving a file from a client application, determining and/or obtaining an applicable preview generator, generating a preview, and providing the preview to the client application as described herein.

Input to and output out of the file management application 722 may be transmitted through a communication device 766 that may be communicatively coupled to the computing device 700. The communication device 766 may provide wired and/or wireless communication. The program data 724 may also include, among other data, previewer data 728 such as a list of registered previewers and corresponding file types, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 766) to the basic configuration 702 via the bus/interface controller 730. Some of the example output devices 742 include a graphics processing unit 748 and an audio processing unit 750, which may be configured to communicate to various external devices such as a display or speakers via one or more A/V ports 752. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example of the communication device(s) 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a specialized server, mainframe, or similar computer, which includes any of the above functions. The computing device 700 may also be implemented as a personal computer including both laptop computer and non-laptop computer configurations. Additionally, the computing device 700 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide an instant preview of a locally unsupported file. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

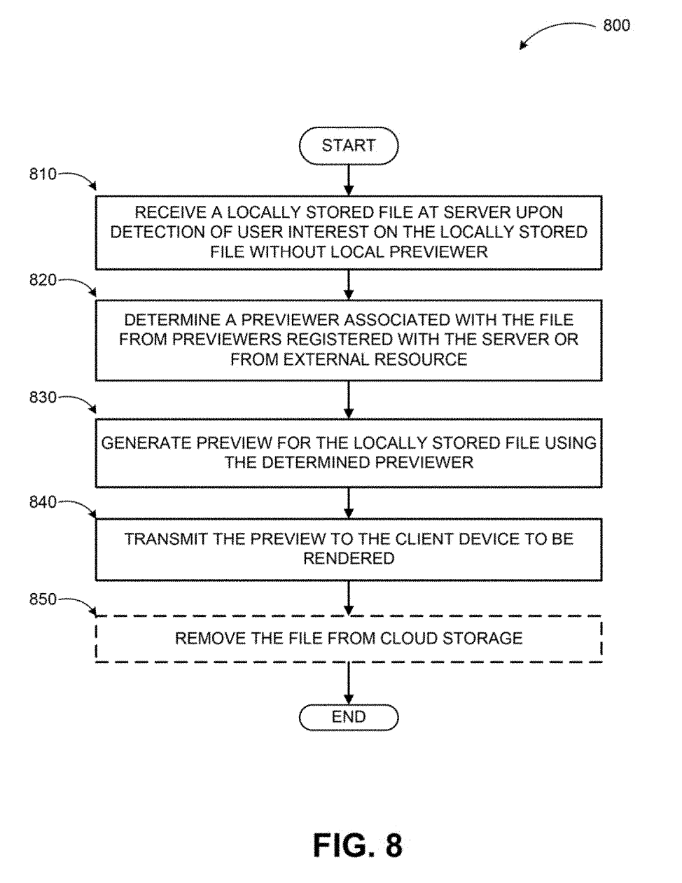

FIG. 8 is a logic flow diagram illustrating a process for providing an instant preview of a locally unsupported file, according to embodiments. Process 800 may be implemented on a computing device, such as the computing device 700 or another system.

Process 800 begins with operation 810, where a locally stored file is received at a server upon detection of user interest on the file at the client device transmitting the file and determination that there is no local preview support for the file. The server may determine a previewer associated with a type of the received file among its registered previewers at operation 820. If there is no registered previewer for the file type, the server may query and obtain the previewer from an external source such as a previewer provider.

At operation 830, a preview for the file may be generated at the server using the determined/obtained previewer. The generated preview may then be transmitted to the client device to be rendered at operation 840. At optional operation 850, the cloud copy of the received file may be removed from cloud storage if the user is not a subscriber.

The operations included in process 800 is for illustration purposes. Providing an instant preview of a locally unsupported file may be implemented by similar processes with fewer or additional steps, as well as in different order of operations using the principles described herein. The operations described herein may be executed by one or more processors operated on one or more computing devices, one or more processor cores, specialized processing devices, and/or special purpose processors, among other examples.

According to examples, a means for providing an instant preview of a locally stored file is described. The means may include a means for detecting an intent to preview the locally stored file; a means for confirming a lack of a local previewer associated with the locally stored file; a means for requesting a preview from a server associated with the locally stored file by providing the locally stored file to the server, where the preview includes a presentation of the locally stored file using a previewer registered with the server; a means for receiving the preview associated with the locally stored file from the server; and a means for rendering the preview associated with the locally stored file.

According to some examples, a method to provide an instant preview of a locally stored file is described. The method may include detecting an intent to preview the locally stored file; confirming a lack of a local previewer associated with the locally stored file; requesting a preview from a server associated with the locally stored file by providing the locally stored file to the server, where the preview includes a presentation of the locally stored file using a previewer registered with the server; receiving the preview associated with the locally stored file from the server; and rendering the preview associated with the locally stored file.

According to other examples, detecting the intent to preview the locally stored file may include detecting one of a hover action, a click action, and a tap action on a representation of the locally stored file through a user interface of a local application. The representation of the locally stored file may include one of a thumbnail, an icon, a shortcut, an image, and a graphic. The method may also include informing the server about whether a user associated with the locally stored file is a subscriber or non-subscriber. The locally stored file provided to the server may be removed from a cloud storage upon generation of the preview at the server if the user is a non-subscriber.

According to further examples, the method may further include receiving an incentive for the user from the server to keep the provided locally stored file in a cloud storage if the user is non-subscriber. Rendering the preview associated with the locally stored file may include rendering the preview that includes one or more of an image, and the interactive element, and editable text associated with content of the locally stored file. The one or more of the image, and the interactive element, and the editable text associated with content of the locally stored file may be included in the preview based on a determination by the server. Confirming the lack of the local previewer associated with the locally stored file may include querying an operating system of a computing device that stores the locally stored file for the local previewer.

According to other examples, a method to provide an instant preview of a locally unsupported file. The method may include receiving a request for a preview for a locally stored file and a copy of the locally stored file from a client application upon detection of an intent to preview the locally stored file and confirmation of a lack of a local previewer associated with the locally stored file by the client application; querying a previewer registry associated with a server receiving the file to determine a previewer associated with the received file; if a registered previewer associated with the file is found, generating the preview using the registered previewer; and providing the preview to the client application.

According to some examples, the method may further include removing the copy of the locally stored file from a temporary cloud storage if a user associated with the file is a non-subscriber. The method may also include generating the preview with a predefined level of functionality based on a subscription status of the user. The method may also include providing one of an incentive and an offer to the user associated with the level of functionality of the preview. The level of functionality may include one of a read only functionality, a limited interactivity functionality, and an editability functionality. The method may also include providing the preview with a first level of functionality for a predefined number of preview requests; and providing the preview with a second level of functionality after the predefined number of preview requests, where the first level of functionality provides a higher level of functionality compared to the second level of functionality.

According to further examples, a server configured to provide an instant preview of a locally stored file is described. The server may include a communication device configured to facilitate communication between the server, a cloud storage, a previewer provider, and a client device; a memory configured to store instructions; and one or more processors coupled to the memory and the communication device, wherein the one or more processors, in conjunction with the instructions stored in the memory, execute a preview management module of a hosted service. The preview management module may be configured to receive a request for a preview for a locally stored file and a copy of the locally stored file from a client application executed on the client device upon detection of an intent to preview the locally stored file and confirmation of a lack of a local previewer associated with the locally stored file by the client application; query a previewer registry associated with the server; if a registered previewer associated with the file is found, generate the preview using the registered previewer; provide the preview to the client application; and remove the copy of the locally stored file from a temporary cloud storage if a user associated with the file is a non-subscriber.

According to yet other examples, the preview management module may be further configured to keep the copy of the locally stored file at a cloud storage if the user associated with the file is a subscriber of the hosted service. The preview management module may also be configured to if the registered previewer associated with the file is not found, query the previewer provider; and generate the preview using a previewer received from the previewer provider. The preview management module may be further configured to collect statistical information associated with preview requests from a plurality of users, the statistical information including a file type, a subscription status, a number of requests per user, and a number of requests per file type; and provide the statistical information to the previewer provider. The preview management module may also be configured to anonymize user information associated with the locally stored file prior to generating the preview.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to provide an instant preview of a locally stored file, the method comprising:
detecting an intent to preview the locally stored file;
confirming a lack of a local previewer associated with the locally stored file;
requesting a preview from a server associated with the locally stored file by providing the locally stored file to the server, wherein the preview includes a presentation of the locally stored file using a previewer registered with the server;
receiving the preview associated with the locally stored file from the server; and
rendering the preview associated with the locally stored file.

2. The method of claim 1, wherein detecting the intent to preview the locally stored file comprises:
detecting one of a hover action, a click action, and a tap action on a representation of the locally stored file through a user interface of a local application.

3. The method of claim 2, wherein the representation of the locally stored file includes one of a thumbnail, an icon, a shortcut, an image, and a graphic.

4. The method of claim 1, further comprising:
informing the server about whether a user associated with the locally stored file is a subscriber or non-subscriber.

5. The method of claim 4, wherein the locally stored file provided to the server is removed from a cloud storage upon generation of the preview at the server if the user is a non-subscriber.

6. The method of claim 4, further comprising:
receiving an incentive for the user from the server to keep the provided locally stored file in a cloud storage if the user is non-subscriber.

7. The method of claim 1, wherein rendering the preview associated with the locally stored file comprises:
rendering the preview that includes one or more of an image, and the interactive element, and editable text associated with content of the locally stored file.

8. The method of claim 7, wherein the one or more of the image, and the interactive element, and the editable text associated with content of the locally stored file are included in the preview based on a determination by the server.

9. The method of claim 1, wherein confirming the lack of the local previewer associated with the locally stored file comprises:
querying an operating system of a computing device that stores the locally stored file for the local previewer.

10. A method to provide an instant preview of a locally unsupported file, the method comprising:
receiving a request for a preview for a locally stored file and a copy of the locally stored file from a client application upon detection of an intent to preview the locally stored file and confirmation of a lack of a local previewer associated with the locally stored file by the client application;
querying a previewer registry associated with a server receiving the file to determine a previewer associated with the received file;
if a registered previewer associated with the file is found, generating the preview using the registered previewer; and
providing the preview to the client application.

11. The method of claim 10, further comprising:
removing the copy of the locally stored file from a temporary cloud storage if a user associated with the file is a non-subscriber.

12. The method of claim 11, further comprising:
generating the preview with a predefined level of functionality based on a subscription status of the user.

13. The method of claim 12, further comprising:
providing one of an incentive and an offer to the user associated with the level of functionality of the preview.

14. The method of claim 12, wherein the level of functionality includes one of a read only functionality, a limited interactivity functionality, and an editability functionality.

15. The method of claim 12, further comprising:
providing the preview with a first level of functionality for a predefined number of preview requests; and
providing the preview with a second level of functionality after the predefined number of preview requests, wherein the first level of functionality provides a higher level of functionality compared to the second level of functionality.

16. A server configured to provide an instant preview of a locally stored file, the server comprising:
a communication device configured to facilitate communication between the server, a cloud storage, a previewer provider, and a client device;
a memory configured to store instructions; and
one or more processors coupled to the memory and the communication device, wherein the one or more processors, in conjunction with the instructions stored in the memory, execute a preview management module of a hosted service, the preview management module configured to:
receive a request for a preview for a locally stored file and a copy of the locally stored file from a client application executed on the client device upon detection of an intent to preview the locally stored file and confirmation of a lack of a local previewer associated with the locally stored file by the client application;
query a previewer registry associated with the server;
if a registered previewer associated with the file is found, generate the preview using the registered previewer;
provide the preview to the client application; and
remove the copy of the locally stored file from a temporary cloud storage if a user associated with the file is a non-subscriber.

17. The server of claim 16, wherein the preview management module is further configured to:
keep the copy of the locally stored file at a cloud storage if the user associated with the file is a subscriber of the hosted service.

18. The server of claim 16, wherein the preview management module is further configured to:
if the registered previewer associated with the file is not found, query the previewer provider; and
generate the preview using a previewer received from the previewer provider.

19. The server of claim 16, wherein the preview management module is further configured to:
collect statistical information associated with preview requests from a plurality of users, the statistical information including a file type, a subscription status, a number of requests per user, and a number of requests per file type; and
provide the statistical information to the previewer provider.

20. The server of claim 16, wherein the preview management module is further configured to:
anonymize user information associated with the locally stored file prior to generating the preview.
